(19) United States
(12) Patent Application Publication
(10) Pub. No.: US 2024/0229484 A9
(43) Pub. Date: Jul. 11, 2024

(54) PROTECTIVE COVER

(71) Applicant: Mera Consultancy & Designs Ltd., Hungerford, Berkshire (GB)

(72) Inventor: Andrew MASON, Hungerford, Berkshire (GB)

(73) Assignee: Mera Consultancy & Designs Ltd., Hungerford, Berkshire (GB)

(21) Appl. No.: 18/276,670

(22) PCT Filed: Feb. 10, 2022
(86) PCT No.: PCT/GB2022/050369

§ 371 Date: Aug. 10, 2023

(30) Foreign Application Priority Data
Feb. 10, 2021 (GB) 2101856.9

(51) Int. Cl. E04G 21/30

(52) U.S. Cl. CPC E04G 21/30; H02G 3/14

(57) ABSTRACT

A protective cover, for shielding a cavity having an opening formed in a wall, floor, or ceiling, during a construction process from ingress of unwanted material is disclosed. The protective cover comprises a cover portion for covering the opening and at least one securing portion for holding the cover portion in place, wherein the at least one securing portion comprises at least one respective coupling portion configured for mutual engagement with a corresponding feature within the cavity whereby, when the at least one coupling portion and the corresponding feature within the cavity are mutually engaged, application of a force to extract the cover from the cavity causes the corresponding feature within the cavity to apply an opposing force to the at least one coupling portion to inhibit extraction of the protective cover from the cavity.

### BACKGROUND

The present invention relates to a protective cover for shielding a cavity. The invention has particular although not exclusive relevance to protecting a cavity formed in a wall, or accessed via an opening cut into a ceiling, during a construction process, from the ingress of unwanted material such as plaster or paint. It will be appreciated, however, that such a protective cover may find application elsewhere.

In modern properties, the need for electrical outlets (also known as electrical sockets, power sockets, plugs, wall/ceiling plugs, and the like) has never been more apparent, given modern demands for sources of power, lighting, and communication connectivity. During the construction of such properties, whether they be commercial or domestic, installation methods with respect to these electrical outlets are broadly similar.

Many electrical outlets comprise a so-called back box, which is inserted into a hole formed in a wall to form a cavity into which electrical components, such as plug sockets/light switches (sometimes referred to as faceplates) are subsequently installed. Back boxes are typically installed in situ during the installation of electrical cabling in the property. It will be appreciated that back boxes could be installed into holes formed in other building elements such as walls, ceilings, and/or floors or the like.

The installation of the back box forms part of a “first fix” installation, usually carried out by an electrician, during the construction process.

As part of the first fix installation, the electrician will typically form holes in the walls into which the back boxes are to be placed. As part of this procedure, cabling is also installed (often run via a conduit, or the like) with respect to each back box, as appropriate for the intended application of the components to be powered by the electrical outlet.

It should be appreciated, however, that some installations during a first fix do not require a specific back box. For example, ceiling downlights, which may advantageously be placed in specific areas of rooms to provide efficient and location-specific lighting, are often inserted into openings cut by an electrician into the building's ceiling to allow access the ceiling cavity. As part of this first fix procedure, the electrician will typically run respective cables through the ceiling void to the opening.

Typically, the electrician will mark the ends of the cabling accessible via the back box/ceiling cavity to be able to easily trace each respective cable back to a consumer unit/main distribution board, thereby simplifying wiring of the property during subsequent stages of the construction process.

When marking cables in this way, the electrician will usually roll the cables up for storage inside the back box/ceiling cavity, placing the cables through the opening associated with each cavity. Oftentimes, plastic bags, adhesive tape, or the like, are used to protect the ends of the cabling being stored and once the cables have been stored in this way, the first fix is complete. Adhesive tape is also sometimes used to cover the back boxes/ceiling cavities installed/prepared by the electrician.

The next stage during a typical construction process will involve a plasterer arriving on site to plaster the building's walls. Given time is normally of the essence in most construction processes (and indeed for the various contractors working on the process), the plasterer will prepare the work area, e.g. the walls/ceilings which have had associated back boxes/cabling installed during the first fix, by removing anything that will catch their trowel and/or slow them down when plastering.

For example, any cabling left protruding from walls will often be pushed back inside the cavity by the plasterer, to avoid the plasterer's trowel's motion across the wall's surface from being interrupted during the plastering procedure.

Unfortunately, whilst most plasterers attempt to be careful when plastering near preinstalled back boxes/pre-cut ceiling cavities, it is almost inevitable that some plaster intended for the wall/ceiling will end up at least partially filling the back box or, indeed, on some occasions depending on the size of the back box, it may be inadvertently filled with plaster entirely.

Moreover, when plastering a ceiling, many plasterers will simply plaster over the taped-over holes pre-cut by the electrician during the first fix installation, because of the inconvenience such holes present with respect to the plasterer's time.

Whilst some plasterers may, of course, be able to extract any plaster which has inadvertently entered the cavity formed by the back box, it is rare for a plasterer to do this given the often-significant time constraints that they are under. This means that the plaster will cure and harden inside the back box, making its subsequent removal problematic and time consuming, thereby creating not insignificant losses with respect to the timings and profits of the construction processes. This problem is exacerbated with respect to openings for accessing cavities in a ceiling which may have been plastered over, as it can take significant time for the electrician to relocate the now-plastered-over cavities formed in the ceiling during the first fix.

These problems mean that when an electrician arrives on site to perform the second fix, i.e. the installation of faceplates for electrical sockets, light switches, etc., into the back box cavities and/or perform the installation of ceiling downlights, valuable time is lost and additional costs are incurred, due to the electrician having to remove unwanted plaster from back boxes/find cavities formed in ceilings, before being able to proceed with any second fix installations.

Accordingly, preferred embodiments of the present invention aim to provide a protective cover which address or at least partially deal with one or more of the above issues.

The present invention is set out in the appended independent claims. Optional features are set out in the appended dependent claims.

According to a first example, there is disclosed is a protective cover, for shielding a cavity having an opening formed in a wall, floor, or ceiling, during a construction process from ingress of unwanted material, the protective cover comprising a cover portion for covering the opening and at least one securing portion for holding the cover portion in place, wherein the at least one securing portion comprises at least one respective coupling portion configured for mutual engagement with a corresponding feature within the cavity whereby, when the at least one coupling portion and the corresponding feature within the cavity are mutually engaged, application of a force to extract the cover from the cavity causes the corresponding feature within the cavity to apply an opposing force to the at least one coupling portion to inhibit extraction of the protective cover from the cavity.

The at least one coupling portion may comprise at least one aperture, formed in the at least one securing portion, and configured for engagement with the corresponding feature within the cavity.

The at least one coupling portion may comprise a recessed portion extending from an edge of the at least one securing portion wherein at least one side of the recessed portion is configured for engagement with the corresponding feature within the cavity.

The at least one side of the recessed portion may comprise at least one notch configured for engagement with the corresponding feature within the cavity.

The protective cover may be configured for installation with a back box for receiving cabling, wherein the corresponding feature within the cavity is a feature of the back box, and wherein the at least one coupling portion is configured for engagement with that feature of the back box.

The back box that the protective cover may be configured for installation with has a plurality of press-out portions for forming at least one aperture through which said cabling can be received, and wherein the at least one securing portion is configured to avoid obstructing said at least one aperture when formed in said back box.

The protective cover may be configured for installation in the opening provided in the wall, floor, or ceiling without a back box for receiving cabling, wherein the corresponding feature within the cavity comprises a surface of the wall, floor, or ceiling that is internal to the cavity, wherein the at least one coupling portion is configured for engagement against said surface, when the protective cover is installed, to inhibit extraction of the protective cover from the cavity.

The at least one coupling portion may comprise a plurality of flared portions that flare outwardly relative to the cover portion, wherein distal ends of the flared portions are spaced at a distance that is wider than the opening, and wherein the at least part of the protective cover that is configured for movement is configured for moving the distal ends of the flared portions closer together, to facilitate said mutual engagement, during insertion of the at least one securing portion into the cavity.

The at least one securing portion may comprise a plurality further portions extending substantially perpendicularly from the cover portion, wherein each flared portion respectively extends from one of the further portions at a distance from the cover portion that corresponds to a thickness of a panel in which the opening is provided.

At least part of the protective cover may be configured for movement relative to at least one other part of the protective cover during insertion of the at least one securing portion into the cavity to facilitate said mutual engagement.

The at least part of the protective cover is may be configured for flexing, to provide said movement as the at least one securing portion is inserted into the cavity, whereby to facilitate said mutual engagement.

The at least one coupling portion may be configured for mutual engagement with the feature within the cavity at a plurality of different possible positions, each different position corresponding to a respective different position of the cover portion relative to the cavity.

Each different position may correspond to a respective different depth of the cover portion relative to the cavity.

The at least one coupling portion may be configured to provide a snap-fit engagement with the feature of the cavity.

The cover portion may have a generally flat surface, and wherein the cover portion and at least one securing portion are mutually configured to present the generally flat surface of the cover portion substantially flush with an external surface of the wall, floor, or ceiling adjacent to the cavity when, in operation, the protective cover is installed.

The cover portion may comprise means for aiding removal of the protective cover from the cavity after installation.

The means for aiding removal of the protective cover may comprise an aperture in the cover portion for receiving a tool or finger.

The protective cover may be manufactured from a recyclable plastics material.

The protective cover may be manufactured from a semi-rigid plastics material.

The protective cover may be manufactured from a transparent material.

According to a second example, a method for protecting a cavity, comprises: installing the above-described protective cover into a cavity.

Each feature disclosed in this specification (which term includes the claims) and/or shown in the drawings may be incorporated in the invention independently (or in combination with) any other disclosed and/or illustrated features. In particular but without limitation the features of any of the claims dependent from a particular independent claim may be introduced into that independent claim in any combination or individually.

Embodiments of the invention will now be described by way of example only with reference to the attached figures in which:

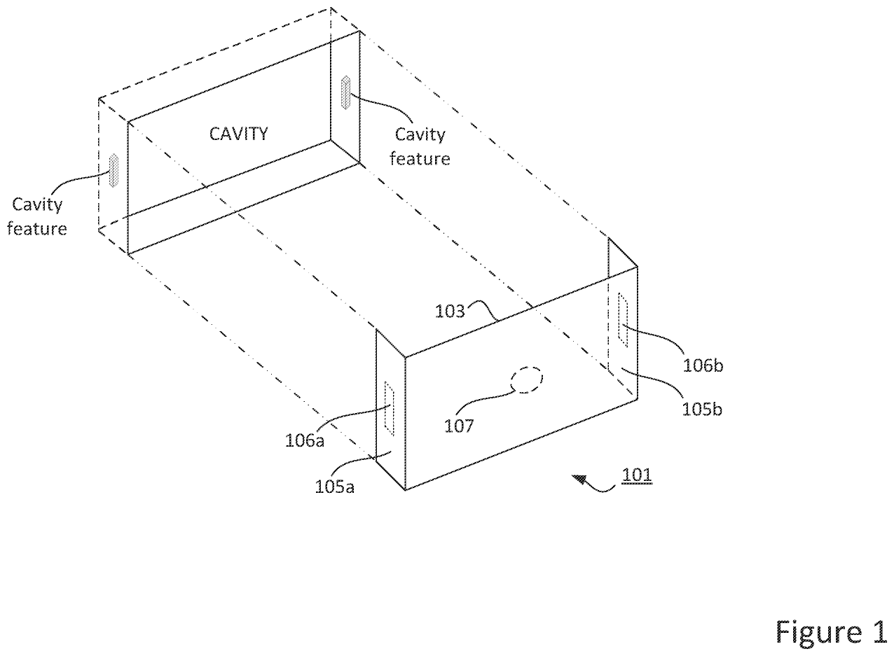

FIG. 1 is a simplified, perspective view of a protective cover and a cavity;

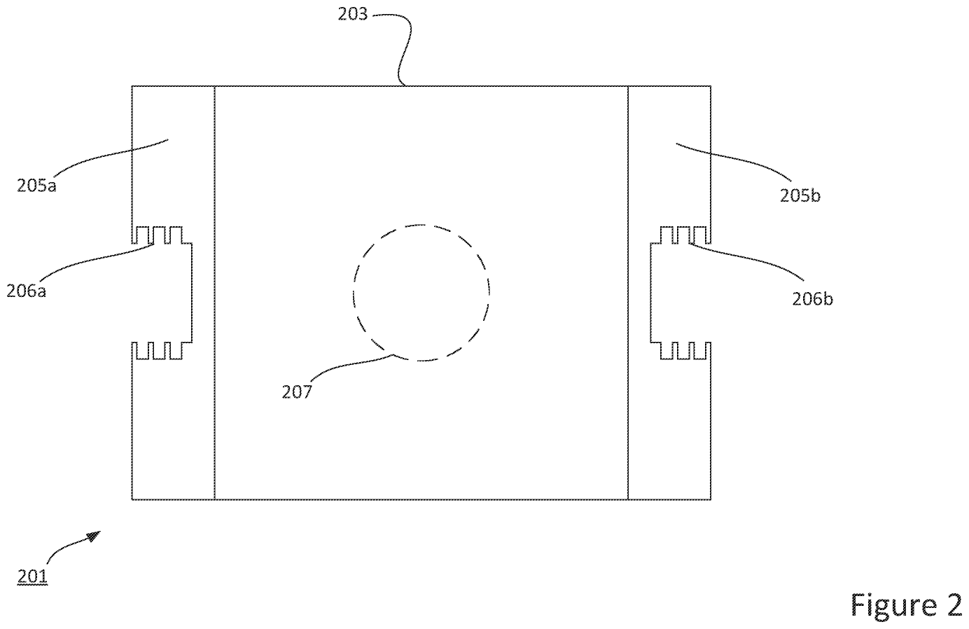

FIG. 2 is a schematic net view of a protective cover for protecting a plastic back box;

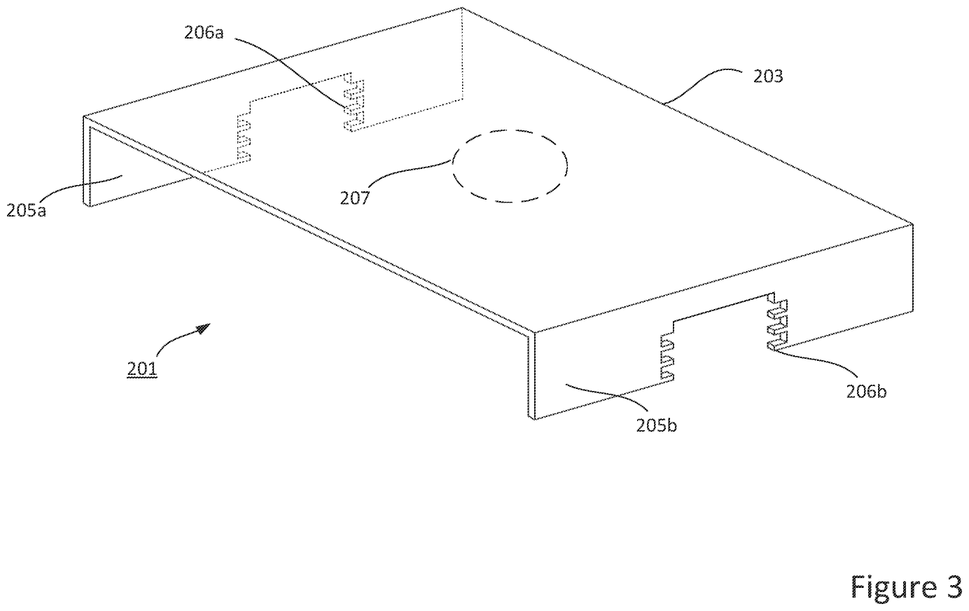

FIG. 3 is a schematic perspective view of a protective cover for protecting a plastic back box;

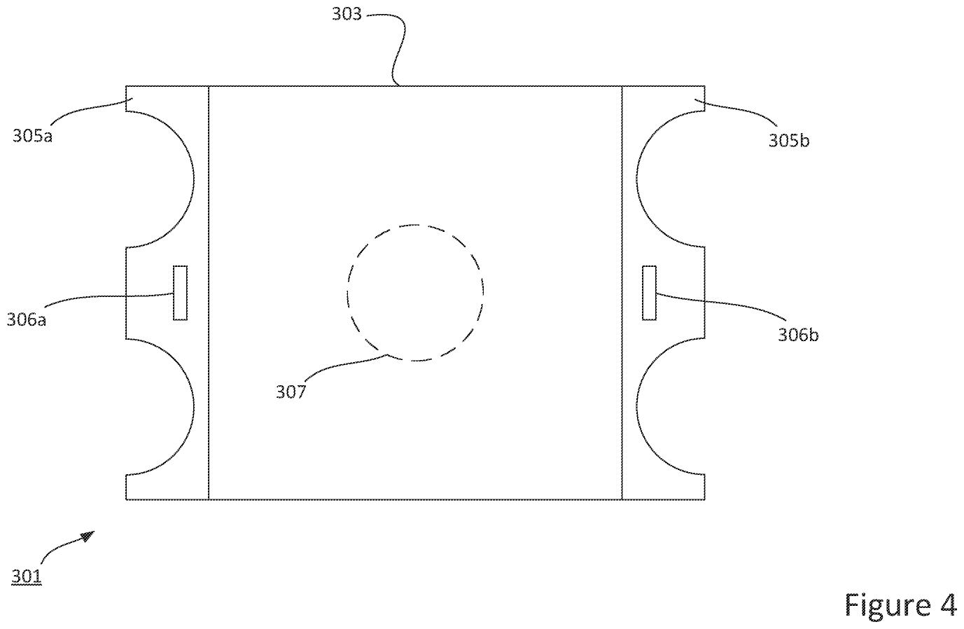

FIG. 4 is a schematic net view of a protective cover for protecting a metal back box;

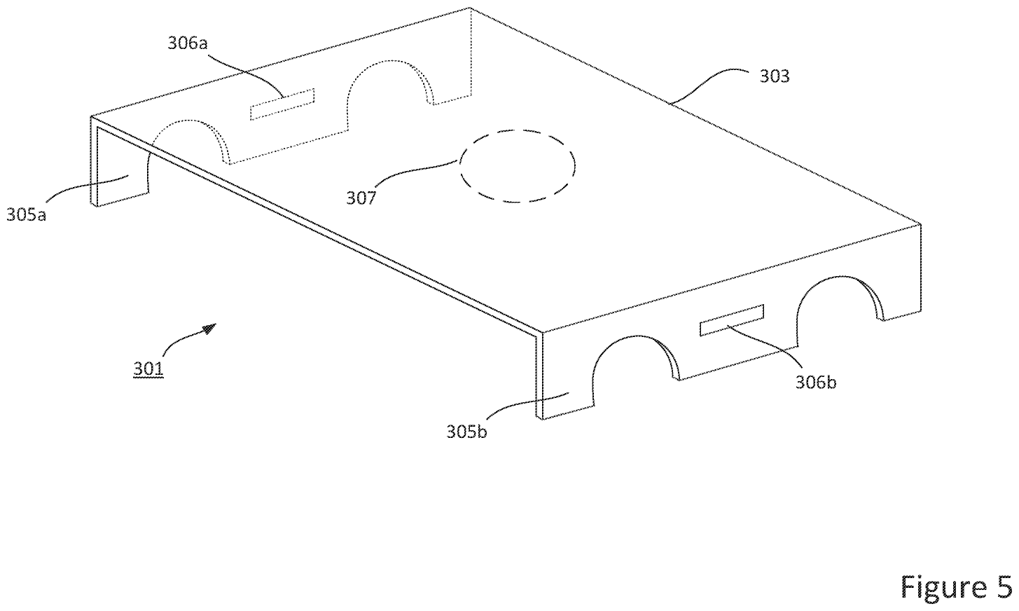

FIG. 5 is a schematic perspective view of a protective cover for protecting a metal back box;

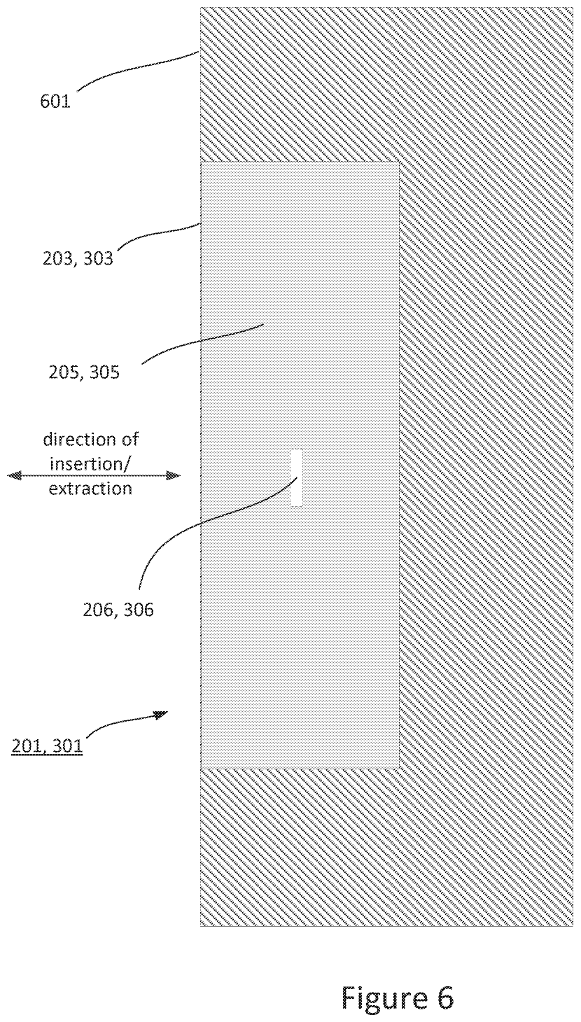

FIG. 6 is schematic cross section showing a protective cover which has been installed within a back box;

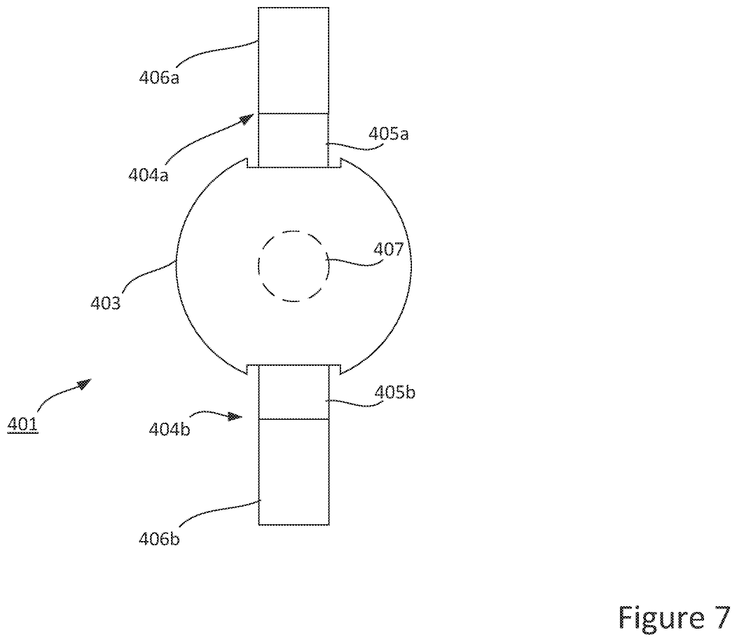

FIG. 7 is a schematic net view of a protective cover for protecting a cavity accessed via an opening cut into a ceiling; and

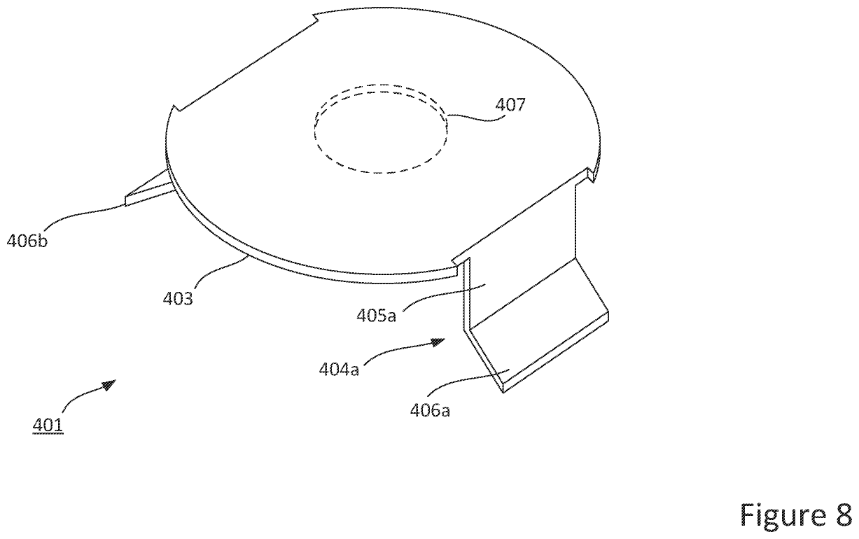

FIG. 8 is a schematic perspective view of a protective cover for protecting a cavity accessed via an opening cut into a ceiling.

### Overview

An exemplary protective cover will now be described in overview by way of example only with reference to FIG. 1.

FIG. 1 illustrates, schematically, a protective cover generally at 101. The protective cover 101 is configured for protecting a cavity having an opening, e.g. a cavity formed by a back box or accessible via an opening cut into a ceiling, from being inadvertently filled with plaster or other unwanted material during a construction process.

As seen in FIG. 1, the protective cover 101 comprises a cover portion 103 for covering the cavity to be protected, and securing portions 105a, 105b for securing the cover 101 in position in the cavity.

It should be appreciated that although the cover portion 103 of the protective cover 101 is shown to be rectangular it can be made to any size or shape, as appropriate. For example, standard sizes of the cover portion 103 can correspond to standardised sizes for square or rectangular plug socket back boxes (e.g. single gang and twin gang sizes, etc.), for light switches of various standard sizes, for standard sizes of circular ceiling downlights, and the like, thereby providing the end-user with a protective cover 101 suitable for their respective needs. A protective cover 101 having a bespoke-sized cover portion 103 may also be used, as required by each specific bespoke application.

The protective cover 101 is held within the cavity to be protected by way of the securing portions 105a, 105b extending generally orthogonally from the cover portion 103.

The securing portions 105a, 105b in this example, are located diametrically opposed to one another on the respective shortest sides of the cover portion 103. In this example, the securing portions 105a, 105b both extend the full height of the cover portion 103 although, whilst this can provide an advantage in terms of additional strength or rigidity, this need not be the case.

It will be appreciated that in other examples of the protective cover 101, any suitable number of securing portions 105a, 105b may be provided. Moreover, the securing portion(s) may be positioned, as required, along a different side or sides to those shown in FIG. 1.

Each securing portion 105a, 105b comprises respective coupling features 106a, 106b for mutual engagement with a corresponding feature provided in the cavity that is being protected, to secure the cover 101 in position. In this example the coupling feature 106a, 106b comprises an aperture formed in the securing portion for engaging with a lug of a backbox (e.g. a lug comprising a screw hole by means of which a faceplate can be secured to the backbox). It will be appreciated that feature of the cavity with which the securing portion 105a, 105b couples can be in any suitable form, such as a protrusion for engaging with a hole in a backbox or the like.

Accordingly, in operation, when the protective cover 101 is inserted by the user into the cavity to be protected, e.g. typically by an electrician during a construction project's first fix, the coupling features 106 of the securing portions 105 engage with the corresponding features provided in the cavity to holds the cover portion in place consequently inhibiting extraction of the protective cover 101 from the cavity. To facilitate such mutual engagement, the protective cover 101 whilst generally rigid may be configured to flex by a small amount as the securing portion 105 is inserted into the cavity to allow such mutual engagement to occur.

The cover portion 103 and its associated securing portion 105 in this example are mutually configured to fit the cavity being protected such that the cover portion 103 which protects the cavity is substantially flush with respect to the surfaces adjacent to the protected cavity (e.g. the external surface of a wall, floor or ceiling). Beneficially, therefore, from the perspective of the plasterer, once the protective cover 101 has been installed into a cavity, the wall/ceiling appears as one substantially flat surface onto which plaster may be applied without inhibiting the plastering operation.

Once installed, the protective cover 101 beneficially covers the cavity, thereby preventing plaster (and any other undesired detritus) from entering the cavity during subsequent stages of the construction process.

Accordingly, once the cavities formed during the first fix have been protected with protective covers, the plasterer is able to arrive on site to plaster the walls/ceilings with their workspace essentially being pre-prepared to receive plaster. Therefore, the plasterer beneficially does not have to waste time in preparing the workspace (e.g. moving cabling/taping cabling inside back boxes, etc.) or take specific precautions when plastering near the protected cavities.

During the next stage of the construction process, and once the plaster has cured, the electrician arrives back on site to perform the second fix and install electrical sockets, light switches, ceiling downlights, and other faceplates, into the cavities protected during the first fix.

To facilitate this subsequent stage of the process, the protective cover 101 according to this example comprises a release feature 107 for aiding removal of the cover 101 from the protected cavity.

It can be seen from FIG. 1 that in this example the release feature comprises an aperture 107 that is provided substantially centrally with respect to the cover portion 103, such that the user can insert a finger or tool into the aperture 107 to hook the cover to assist removal of the cover from the cavity.

Of course, it should be appreciated that an alternative release feature 107 the protective cover 101 could be provided on the cover portion 103, such as further apertures, pull tab(s), or the like. Whilst apertures are preferable, as they are flush to the surface of the cover portion 103 and therefore present less of an obstacle to a plasterer, pull tab(s) or the like may be used instead to further eliminate the risk of plaster entering the cavity being protected relative to the cover portion 103 having an aperture 107.

Alternatively, it should be understood that removal of the cover 101 from the cavity can be effected without the need to use the release feature 107 described above. Instead, a tool could be placed between the protective cover 101 and the protected cavity, and the cover 101 may be urged out of the cavity using by leveraging the tool.

Accordingly, the electrician may readily remove the protective cover 101 by urging the device out of the protected cavity, thereby revealing a cavity free from plaster. The electrician may then proceed with the steps of the second fix, without any issues caused by ingress of plaster (or other unwanted detritus) into back boxes, or without difficulty in finding ceiling downlight cavities which may have otherwise been plastered over.

Use of the disclosed protective cover, therefore, saves time and costs for the parties involved in the construction process.

The protection device 1 will now be described in greater detail, by way of example only, with respect to the examples illustrated in FIGS. 2 to 8.

### Protective Cover for a Back Box

Before discussing specific exemplary protective covers for back boxes in greater detail, it should firstly be appreciated that several types of back box are used by the construction industry, having various widths, heights, and depths. Two types of back box which are commonly in use in industry are made of plastic or metal.

Plastic back boxes are often installed in stud partition walls, i.e. walls/ceilings which are made from a stud frame (which is typically made of wood) over which plasterboard (or other materials, such as wood) is affixed.

An appropriate size hole is cut into the plasterboard to receive the plastic back box during a first fix procedure and during this procedure, cabling is often run between the back box and the distribution board/consumer unit through the void inside the partition wall, although it should be appreciated that specific conduit(s) may be installed to receive cabling as required.

Plastic back boxes normally comprise at least one portion which engages with the plasterboard's surface when the back box is fully installed. For example, one or more plastic lugs may be provided within the back box which grip the plasterboard when the faceplate (e.g. the plug socket/light switch) is screwed into the back box.

The portion of the plastic back box which engages with the plasterboard's surface has its own surface features, which may differ depending on the manufacturer of the back box.

The alternative metal back boxes are often installed in solid walls/ceilings, e.g. those made of solid stone, precast concrete, bricks, or the like, during a first fix procedure.

An appropriate size hole is cut/chiselled into the solid material to receive the metal back box. Often, conduit is also cut/chiselled into the solid material to receive cabling which will be routed between the back box and the distribution board/consumer unit.

Metal back boxes normally comprise at least one portion which engages with the faceplate to be installed onto the back box. For example, one or more metal lugs may be provided within the metal back box to which the faceplate is secured when it is screwed into the back box.

It should therefore be appreciated that both plastic and metal back boxes (in addition to other types of back boxes) comprise a feature within their respective cavities which may mutually engage with the coupling feature(s) of the protective cover.

An example of a protective cover which is particularly suitable for a range of currently available plastic back boxes is illustrated in FIGS. 2 and 3. FIGS. 2 and 3 respectively schematically illustrate a net (or flattened) view and a perspective view of a protective cover 201 which is suitable for protecting the cavity formed by the plastic back box from ingress of plaster (or of other unwanted detritus).

As seen in FIGS. 2 and 3, the protective cover 201 comprises a cover portion 203 for covering the cavity to be protected, and securing portions 205a, 205b which comprise respective coupling portions 206a, 206b for mutually engaging with a respective feature within the cavity of the back box. As an aside it ought to be appreciated that a cover comprising an integral coupling portion, as disclosed herein, is beneficial compared to having to use alternative coupling means to affix a protective cover. For instance, screws could be used to affix the protective cover, but these screws have to be fastened/unfastened each time the cover is installed/removed (taking considerable time on e.g. a multi-floor construction project having several hundred/thousand back boxes). Moreover, this type of fixing could even be plastered over, thereby making extraction of the protective cover troublesome and time consuming during the second fix.

According to this example, each securing portion 205a, 205b extends generally perpendicularly from cover portion 203. Each coupling portion 206a, 206b is in the form of a generally rectangular recess extending from a longitudinal edge of the securing portion 205a, 205b that is distal to the cover portion 203, towards a longitudinal edge of the securing portion 205a, 205b that is shared with the cover portion 203.

Each rectangular recess comprises a pair of notched sides opposite one another. In this example, the notched sides form a plurality of pairs of opposing notches (in this example three) at different distances from the longitudinal edge shared between the securing portion 205a, 205b and the cover portion 203. Each pair of notches is configured to secure the cover portion 203 in place by mutual engagement with a feature within the cavity formed by the back box (e.g. the one or more plastic lugs of the plastic back box). Specifically, the feature of the back box is received into corresponding pair of notches in the cavity and abuts the sides of the notch to inhibit movement of the protective cover 201. Extraction of the protective cover 201, once installed to protect the cavity, is thus inhibited by the sides of the pair of notches by which it is secured in place.

The coupling portion 206a, 206b may, in other words, be understood to allow the cover 201 to snap-fit to the features of the back box within the cavity. The presence of the plurality of pairs of notches (in this example three) at a number of different depths relative to the cover portion 203 beneficially allows the cover 201 to be used with back boxes of different depths, whilst ensuring the cover portion can be installed with its outermost surface nearly flush with the surrounding surface of the wall (or floor or ceiling) in which it is installed.

Accordingly, it should be appreciated that a single protective cover 201 may advantageously be used to protect cavities of various plastic back boxes having different depths. However, it should equally be understood that whilst three pairs of notches are shown in this example any appropriate number of pairs of notches may be present in the coupling portions 206a, 206b including a single pair of notches or even a single notch.

Whilst the protective cover 201 is generally rigid, it may be configured to flex by at least a small amount as the securing portion 205 is inserted into the cavity to facilitate the above-described mutual engagement.

The ability of the protective cover 201 to flex also facilitates extraction of the cover 201 from the cavity.

To further aid extraction of the protective cover 201, the cover portion 203 is provided with a release feature 207 which, in this example, is in the form of a generally circular hole provided through the cover portion 203.

Accordingly, in this example extraction can be achieved by a user inserting a finger or tool into the hole 207 to hook the cover and urging the cover 201 out of the cavity.

Different means for releasing may be provisioned, such as additional apertures, pulls tabs, or the like.

Alternatively, the cover may be removed from the cavity without the need for such a release feature 207, e.g. a user could place a tool between the cover 201 and the back box to prise the cover 201 out of the cavity in which it is engaged.

Another example of a protective cover which is particularly suitable for a range of currently available metal back boxes is illustrated in FIGS. 4 and 5. FIGS. 4 and 5 respectively schematically illustrate a net (or flattened) view and a perspective view a protective cover 301 which is suitable for protecting the cavity of formed by the back box from ingress of plaster (or of other unwanted detritus).

As seen in FIGS. 4 and 5, the protective cover 301 comprises a cover portion 303 for covering the cavity to be protected, and securing portions 305a, 305b which comprise respective coupling portions 306a, 306b for mutually engaging with a respective feature within the cavity of the back box.

According to this example, the longitudinal edges of the securing portions 305a, 305b comprise generally semi-circular portions. These semi-circular portions are arranged to overlap, when the cover 301 is installed, with corresponding portions of the back box. Due to these respective portions overlapping, electrical cabling may be routed therethrough.

Also according to this example, each securing portion 305a, 305b of the protective cover 301 extends generally perpendicularly from cover portion 303. Each coupling portion 306a, 306b is in the form of a generally rectangular aperture located generally centrally, in the longitudinal direction, in its respective securing portion 305a, 305b.

Each aperture is configured to hold the cover portion in place by respective mutual engagement with a corresponding feature within the cavity formed by the back box (e.g. the one or more metal lugs within the metal back box) to inhibit extraction of the protective cover 301, once installed to protect the cavity. The aperture 306a, 306b may, in other words, be understood to snap-fit over the feature within the cavity.

Whilst in this example the coupling portion's aperture 306a, 306b is shown as rectangular (to facilitate mutual engagement with a respective rectangular cross-section metal lug inside the back box's cavity), an alternatively shaped opening within the securing portion 305a, 305b may be used as required (e.g. as dictated by the shape of a corresponding feature present within the back box's cavity).

Moreover, whilst in this example the coupling portion comprises a single aperture 306a, 306b it will be appreciated that a plurality of apertures may be provided at different depths relative to the cover portion 303. Whilst metal back boxes typically comprise a single pair of metal lugs, with which the apertures 306a, 306b can couple, various configurations of such lugs are theoretically possible. Accordingly, a protective cover 301 in which each securing portion 305a, 305b comprises a plurality of apertures 306a, 306b at different positions for engaging with different arrangements (e.g. depths) of lugs may beneficially be used to allow the cover to be used more universally.

Whilst the protective cover 301 is generally rigid, it may be configured to flex by a small amount as the securing portion 305 is inserted into the cavity to facilitate the above-described mutual engagement.

To further aid extraction of the protective cover 301, the cover portion 303 is provided with a release feature 307 which, in this example, is in the form of a generally circular hole provided through the cover portion 303.

Accordingly, in this example extraction can be achieved by a user inserting a finger or tool into the hole 307 to hook the cover and urging the cover 301 out of the cavity. Different means for releasing may be provisioned, such as additional apertures, pulls tabs, or the like.

Alternatively, the cover may be removed from the cavity without the need for such releasing means 307, e.g. a user could place a tool between the cover 301 and the back box to prise the cover 301 out of the cavity in which it is engaged.

The above-described protective covers 201, 301 may be beneficially produced in a range of different sizes, e.g. single, double, triple etc. gang plug sockets; single, double, triple etc. gang light switches, to fit the various sizes of back boxes which are used during construction processes. Of course, it should also be appreciated that the above-described protective covers may be produced in any other size as needed by alternative back boxes.

FIG. 6 schematically illustrates, in cross section, a protective cover 201, 301 which has been installed within a back box (such as a plastic or metal back box, as described above), said back box being installed in a wall/ceiling 601.

As illustrated, at least one member of coupling portion 206, 306 has mutually engaged with a feature within the cavity formed by the back box (omitted for clarity), thereby inhibiting extraction of the protective cover 201, 301 in the direction indicated until desired.

Moreover, in this example the cover portion 203, 303 is shown as being substantially flush with respect to the wall 601. Installing the protective cover 201, 301 in this way facilitates a straightforward and time saving plastering process later in the construction process, as the protective cover 201, 301 does not represent an obstruction to the motion of the plasterer's trowel across the wall's surface 601.

### Protective Cover for Ceiling Downlighting

In addition to protecting the cavity of back boxes, as described above, another example of a protective cover is particularly suitable for protecting cavities accessed via an opening cut into a ceiling for the provision of downlighting is illustrated in FIGS. 7 and 8.

FIGS. 7 and 8 respectively schematically illustrate a net (or flattened) view and a perspective view of a protective cover 401 which is suitable for protecting the opening of a ceiling (or the like) from ingress of plaster (or of other unwanted detritus).

As illustrated in FIGS. 7 and 8, the protective cover comprises a cover portion 403 for covering the ceiling cavity's opening, and a pair of securing portions 405a, 405b each of which comprise respective coupling portions 406a, 406b for mutually engaging with a respective feature within the ceiling's opening.

The cover portion 403 is this example is generally circular in profile, as holes for ceiling downlights are generally cut circularly, though alternatively shaped cover portions (e.g., oval, square, rectangular, or the like) may be used as required.

In this example, each securing portion 405a, 405b, comprises a first portion 404a, 404b, that extends substantially perpendicularly from opposing edges of the cover portion 403. In this example, each coupling portion comprises a respective second portion 406a, 406b that flares outwardly at an angle from a distal end of the first portion 404a, 404b such that the distance between the distal ends of the second portions 406a, 406b is larger than a diameter of the hole into which the securing portions 405a, 405b are to be inserted.

The first and second portions of the securing portions 406a, 406b have dimensions configured such that, when the cover 401 is in position in the hole in the ceiling, an external surface of the cover portion 403 is positioned generally flush with the surrounding surface of the ceiling. For instance, the first portion may be made to a length consistent with the thickness of common building materials, such as plasterboard or wood, thereby facilitating proper positioning of the second portion within the cavity. It should be appreciated, though, that the first portion may be made to any given length as required.

To insert such a protective cover 401 into an opening formed in a ceiling, the securing portions 405a, 405b may be flexed inwardly with respect to the centre of the cover portion 403, thereby reducing the distance between the respective distal ends of the flared second portions 406a, 406b, such that the protective cover 401 can be placed inside the ceiling's opening.

Once the inwardly flexed securing portions 405a, 405b are released, the securing portion 405a, 405b will adopt its original conformation, thus increasing the distance between the flared portions 406a, 406b to secure the cover in place.

Accordingly, in this example, it is mutual engagement between the flared coupling portions 406a, 406b and a feature of the ceiling cavity in the form of the rim or surface, internal to the ceiling cavity, that holds the cover portion 401 in place. Extraction of the protective cover 401 from the cavity is thus inhibited until desired.

Whilst the protective cover 401 is generally rigid, it may be configured to flex by at least a small amount as the securing portion 405 is inserted into the cavity to facilitate the above-described mutual engagement.

The ability of the protective cover 401 to flex also facilitates extraction of the cover 401 from the cavity.

To further aid extraction of the protective cover 401, the cover portion 403 is provided with a release feature 407 which, in this example, is in the form of a generally circular hole provided through the cover portion 403.

Accordingly, in this example extraction can be achieved by a user inserting a finger or tool into the hole 407 to hook the cover and urging the cover 401 out of the cavity. Different means for releasing may be provisioned, such as additional apertures, pulls tabs, or the like.

Alternatively, the cover may be removed from the cavity without the need for such a release feature 407, e.g. a user could place a tool between the cover 401 and the ceiling to prise the cover 401 out of the ceiling cavity in which it is engaged.

### Modifications and Alternatives

Detailed examples have been described above. As those skilled in the art will appreciate, a number of modifications and alternatives can be made to the above examples whilst still benefiting from the inventions embodied therein.

In addition to the above described plastic and metal back boxes, which are installed inside wall/ceiling voids, an alternative type of “surface mounted” back box may be used in industry. These surface back boxes, also referred to as pattress boxes, are affixed directly to a wall or ceiling, rather than into a cavity formed in the wall or ceiling, and therefore project out of the wall/ceiling's surface.

Similarly, this type of back box also comprises a feature within its cavity which is suitable for mutual engagement coupling portions of the above described protective covers 201, 301. Accordingly, the protective cover according to the present disclosure, is advantageously able to protect the cavity of plastic, metal, and pattress back boxes from the ingress of plaster (or other such unwanted material).

Although the protective covers 201, 301, 401 for respectively protecting plastic and metal back boxes, and openings formed in ceilings, were described above as devices for protecting against the ingress of unwanted material such as plaster or paint, it should be understood that these covers may instead be used to protect live circuitry which has already been installed in back boxes/ceiling cavities, e.g. when faceplates are taken off for replacement/repair.

Whilst protective covers 201, 301 for respectively protecting plastic and metal back boxes were described above as having “female” coupling features (e.g. the notched portion 206a, 206b and the aperture 306a, 306b) and the back box was described as having “male” features (e.g. the plastic/metal lugs which mutually engage with their respective female counterparts), it should be appreciated that the protective covers 201, 301 could instead comprise the male features and the back boxes could comprise the female features. It should also be appreciated that such protective covers may comprise a mix of such features, e.g. a mix of notched portions and apertures.

Although the protective covers 201, 301 have been described as comprising a “passive” coupling features, it will be appreciated that in one alternative such covers may instead be provisioned with an “active” coupling feature (i.e. a multi-component feature). Examples of an active coupling feature include e.g. a mechanism with a moveable latch or the like, which engages with the respective feature within the cavity as the cover is inserted into the cavity.

Moreover, whilst the coupling features described above are particularly beneficial, other forms of coupling features may be used where appropriate. For example, such coupling feature(s) may include: a hook; a magnetic coupling; a clip; a push fit element; and/or the like.

The protective covers described herein may optionally be made from a recyclable plastics material. This material may be a semi-rigid transparent plastics material. Beneficially, the transparent material enables straightforward identification of installed electrical cabling, thereby acting as a reminder to the plasterer to take precautions when plastering around the protected cavity.

The protective covers described herein may comprise a visual warning, such as “DO NOT REMOVE”, to provide an indication that persons working on the construction process ought to leave the protective covers in position. Other information may also be provided on the protective covers described herein, such as the width/diameter of the protective cover, to aid the user in making an appropriate selection.

Various other modifications will be apparent to those skilled in the art and will not be described in further detail here.

1. A protective cover, for shielding a cavity having an opening formed in a wall, floor, or ceiling, during a construction process from ingress of unwanted material, the protective cover comprising a cover portion for covering the opening and at least one securing portion for holding the cover portion in place,
wherein the at least one securing portion comprises at least one respective coupling portion configured for mutual engagement with a corresponding feature within the cavity whereby, when the at least one coupling portion and the corresponding feature within the cavity are mutually engaged, application of a force to extract the cover from the cavity causes the corresponding feature within the cavity to apply an opposing force to the at least one coupling portion to inhibit extraction of the protective cover from the cavity.

2. The protective cover according to claim 1, wherein the at least one coupling portion comprises at least one aperture, formed in the at least one securing portion, and configured for engagement with the corresponding feature within the cavity.

3. The protective cover according to claim 1, wherein the at least one coupling portion comprises a recessed portion extending from an edge of the at least one securing portion wherein at least one side of the recessed portion is configured for engagement with the corresponding feature within the cavity.

4. The protective cover according to claim 3, wherein the at least one side of the recessed portion comprises at least one notch configured for engagement with the corresponding feature within the cavity.

5. The protective cover according to claim 1, wherein the protective cover is configured for installation with a back box for receiving cabling, wherein the corresponding feature within the cavity is a feature of the back box, and wherein the at least one coupling portion is configured for engagement with that feature of the back box.

6. The protective cover according to claim 5, wherein the back box that the protective cover is configured for installation with has a plurality of press-out portions for forming at least one aperture through which said cabling can be received, and wherein the at least one securing portion is configured to avoid obstructing said at least one aperture when formed in said back box.

7. The protective cover according to claim 1, wherein the protective cover is configured for installation in the opening provided in the wall, floor, or ceiling without a back box for receiving cabling, wherein the corresponding feature within the cavity comprises a surface of the wall, floor, or ceiling that is internal to the cavity, wherein the at least one coupling portion is configured for engagement against said surface, when the protective cover is installed, to inhibit extraction of the protective cover from the cavity.

8. The protective cover according to claim 7, wherein the at least one coupling portion comprises a plurality of flared portions that flare outwardly relative to the cover portion, wherein distal ends of the flared portions are spaced at a distance that is wider than the opening, and wherein the at least part of the protective cover that is configured for movement is configured for moving the distal ends of the flared portions closer together, to facilitate said mutual engagement, during insertion of the at least one securing portion into the cavity.

9. The protective cover according to claim 7, wherein the at least one securing portion comprises a plurality further portions extending substantially perpendicularly from the cover portion, wherein each flared portion respectively extends from one of the further portions at a distance from the cover portion that corresponds to a thickness of a panel in which the opening is provided.

10. The protective cover according to claim 1, wherein at least part of the protective cover is configured for movement relative to at least one other part of the protective cover during insertion of the at least one securing portion into the cavity to facilitate said mutual engagement.

11. The protective cover according to claim 10, wherein the at least part of the protective cover is configured for flexing, to provide said movement as the at least one securing portion is inserted into the cavity, whereby to facilitate said mutual engagement.

12. The protective cover according to claim 1, wherein the at least one coupling portion is configured for mutual engagement with the feature within the cavity at a plurality of different possible positions, each different position corresponding to a respective different position of the cover portion relative to the cavity.

13. The protective cover according to claim 12, wherein each different position corresponds to a respective different depth of the cover portion relative to the cavity.

14. The protective cover according to claim 1, wherein the at least one coupling portion is configured to provide a snap-fit engagement with the feature of the cavity.

15. The protective cover according to claim 1, wherein the cover portion has a generally flat surface, and wherein the cover portion and at least one securing portion are mutually configured to present the generally flat surface of the cover portion substantially flush with an external surface of the wall, floor, or ceiling adjacent to the cavity when, in operation, the protective cover is installed.

16. The protective cover according to claim 1, wherein the cover portion comprises an aperture in the cover portion for receiving a tool or finger.

17. (canceled)

18. The protective cover according to claim 1, wherein the protective cover is manufactured from a recyclable plastics material.

19. The protective cover according to claim 1, wherein the protective cover is manufactured from a semi-rigid plastics material.

20. The protective cover according to claim 1, wherein the protective cover is manufactured from a transparent material.

21. A method for protecting a cavity, comprising:
installing the protective cover according to claim 1 into said cavity.
